(19) United States
(12) Patent Application Publication
(10) Pub. No.: US 2008/0010138 A1
(43) Pub. Date: Jan. 10, 2008

(54) Infused keywords

(76) Inventors: Alan Gunshor, San Francisco, CA (US); Russell Dewey, Los Altos, CA (US)

Correspondence Address: ALAN GUNSHOR, #208, 2035 FILBERT STREET, SAN FRANCISCO, CA, 94123, US

(21) Appl. No.: 11/471,305

(22) Filed: Jun. 21, 2006

(51) Int. Cl. G06Q 30/00

(52) U.S. Cl. 705/14

(57) ABSTRACT

A method and system for allowing a regional advertiser or publisher or merchant to assemble one or more natural language phrases: from information about the advertiser or publisher or merchant, from the region in which they wish to associate, from natural language phrases with which they wish to associate, from data feeds, and from programmatic instructions they wish to convey. When an enduser uses natural language phrases in a search or directory navigation system that matches the natural language phrases placed in the system, directly or indirectly, provided by the advertiser or publisher or merchant, text and/or glyphs are returned along with the company business listing so as to explain to a user why the result set matches the enduser request. An application programming interface ensures that, if a business is listed as a regional advertiser or publisher or merchant, then the text and/or glyph is stored in association with the business listing. The enduser accesses the system via web, wireless, or a voice-driven interface.

### FIELD OF THE INVENTION

The present invention generally relates to Internet search engines and directories, and more specifically to a system for displaying advertisers, publishers, or merchants in an Internet search engine or Internet directory.

### BACKGROUND OF THE INVENTION

Online local advertising, as it exists today, fails to provide enough value for the advertiser as an interactive and scalable medium. It fails to meet the four fundamental pillars of marketing value simultaneously. The four pillars of online local advertising are the same “Four P's of Marketing”, which are:
PRODUCT—knowing what the customer wants (and where he wants to buy it)
PROMOTION—enabling the advertiser to put a successfully convincing message in front of her
PLACEMENT—enabling the advertiser to successfully attract the customer based on where a message is placed
PRICE—enabling the advertiser to successfully reach him in a cost effective manner relative to the benefit received from the local sale, as well as the price of a product and the cost of the ad.

Customers (i.e. a search engine user) and advertisers (also called marketers, publishers, and merchants at different points in this document) expect more value from online and wireless publishing mediums relative to other publishing mediums, because these mediums are easier to access, easier to publish to, have economies of scale, reach more users, are measurable, and are easily improved over time. However, publishers and marketing solution providers have been slow to recognize the current deficiencies of online local advertising, and as a direct result, have been slow to produce the inventions necessary to meet this level of expectation. The required inventions have not been produced because, until now, few people have seen the need to improve on what may currently be the most effective of all the marketing mediums (interactive/online) to a point of further maturity.

There are many examples of online local marketing solutions, tools, publishing methods, and applications that fail to meet the standards of the four pillars, and because each solution is flawed, and because each solution does not cover the flaws of the others, even when combined in a unified effort, these solutions don't achieve the standard.

Attempts to have the customer work harder to find the advertiser fail because
He may not wish to submit a more advanced search (i.e. using a two-part search box form, to search for “<what> near <where>”).
He may not know how to perform a more advanced search.
He may not understand the likelihood of improving his search results with a more advanced search.
He may not wish to navigate a hierarchical directory structure.
He may not know the ultimate location of his target within the hierarchical structure presented to him.
He may not be using the exact search terms that would provide a successful hit on his desired target.

Attempts to know the customer better so that the advertiser can target him more efficiently fail because
Classifying the user based on the location of his DSL billing address (otherwise known as a “Geographic IP” or “Geo IP” database) has very little to do with determining what he intends to purchase, or where he will be when making the purchase, assuming this technique can even find the correct address at all. Reducing an advertiser's need to rely on unsuitable audience prediction tools (like Geo IP), as a primary means of targeting a customer, is a central theme of our invention.
Tracking his historical activity, through cookies and JavaScript, has a very limited ability to predict his future actions.

Attempts to provide the customer with more customized information fail because
Local segmentation strategies inevitably lead publishers to use more data, not better data. And as a result, most publishers compensate by using the same data sources (i.e. yellow pages and maps) because these data sets can be obtained rather inexpensively or for free.
He may not find what he wants from any publisher when every publisher relies on the same generic yellow pages data as the skeleton of their content. For example, assume a continuum of product quality. On one end of the continuum is a set of restaurants with the word ‘pizza’ in their name and in their description. We'll call this first group “yellow pages friendly advertisers”. On the other end of the continuum is a group of restaurants without the word ‘pizza’ in their name and description. All things being equal, the second group of restaurants that does not have the word ‘pizza’ in their name and description will always be the favored set of restaurants, because there are many other factors by which people make their eating decisions, including: word of mouth endorsements and the merchant's ability to describe their own business (beyond the inherent limitations of a one inch yellow pages ad).

Attempts to provide the marketer with tools to publish more customized information given their time and resource constraints fail because these solutions sacrifice best practices for a more generic data structure and metadata structure in order to enable a faster time-to-publish.

Attempts to provide a more cost effective solution for marketers fails because this merely leads to a greater quantity of the same quality ads, all things being equal.

Proof that it is possible that the information the customer is searching for simply doesn't yet exist online comes from asking a litmus test question: “Is there a resource, online or offline, where a merchant can go to transfer all of the pertinent knowledge about the specific market they serve, the products or services they provide, the distance they would go to gain a new customer, even the names of the towns, streets, stores, landmarks and other placename locations that are most successful in funneling new customers to the merchant's door? Is there a single place that acts as a home for the merchant's database of their market intentions, territories, differentiation, and resource limitations? Is there a way to transfer the knowledge the merchant has about their business into an actionable online local advertising strategy? And is there a way to manage this effort efficiently over time as changes in business conditions occur?” Based on the above current state assessment of the industry, the answer to each of these questions must be “No”. The solution to these problems is what we have invented.

### SUMMARY OF THE INVENTION

We have invented a method and a process that enables a regional business to improve how they promote their products and services online to Internet search engine users by creating a set of natural language phrases that are infused with geospatial context. Our system, when integrated with a search engine, improves the likelihood that the search engine user will find the merchant, even if the merchant's physical address is outside the stated area of interest, and even when the search phrase contains non-obvious contextual information (including, but not limited to locations, audiences, and their activities) that cannot be accurately interpreted by the search engine itself without the benefit of our system.

Merchants use our system to assemble their own custom location-infused natural language search phrases, which are also referred to as “Local Names” in this application. For example, a pizza restaurant in San Francisco creates a set of phrases that includes “pizza near SOMA”. The merchant builds then accepts this phrase as part of their Local Name set, because SOMA is within their delivery area. When the enduser searches for “pizza near SOMA”, they now have a better chance of finding this merchant in the result set, even if the merchant's physical address is outside the search area, and even if the phrase contains non-obvious information that would otherwise be inaccurately interpreted by the search engine.

The benefits of our system include:
Improving the likelihood that the merchant and customer find each other, even when the physical location is outside the stated area, and even when the search phrase contains non-obvious information.
Improving the merchant's ability to place successfully convincing message in front of the enduser.
Reducing the cost and work required for a merchant to build large sets of relevant search terms to attract a local customer.

More specifically, our invention can work:
In a manner that does not require the end user, the merchant, or the search engine to change behavior.
Without presenting the user with a hierarchical directory to navigate
Without a customer prediction system (like Geo IP or cookies) even when the end customer does not know the exact search expression
Independent of the knowledge of the ultimate location of the end customer's desired target
Without the use of guesswork as to the current, intended, or home location of the customer or the location of the customer's target search expression.
Without historical user activity data.
Despite the limited metadata provided by “real-time publishing” solutions.
In an online or wireless or voice-driven solution.
In a variety of online publishing systems, including, but not limited to, Internet search engines, Internet directories, blogs, online stores, web pages, auctions, ad servers, and portals.
With various input and output devices, i.e. mouse, keyboard, speakers, or microphones.
In-car, out-of-car, or away-from-car, whether in motion or in a resting state.
With or without the benefit of a GPS service, whether hardware-based or service-based.
In conjunction with budgeting systems.
While still making the advertisements dynamically-relevant.
And even if the data source comes from a data feed or is manually entered using direct data entry.

### BRIEF DESCRIPTION OF THE DRAWINGS

FIG. 1 is a block diagram representing a computer system into which the present invention may be incorporated;

FIG. 2 is a functional block diagram that represents an illustrative system for providing regional service merchant listings for a search in accordance with one aspect of the present invention;

FIGS. 3 and 4 are representations of data entries for a business in accordance with one aspect of the present invention;

FIG. 5 is a representation of a search page for accessing search engine information in accordance with one aspect of the present invention;

FIG. 6 is a representation of four data entries for a business in accordance with one aspect of the present invention;

FIG. 7 is a representation of a data entry for maintaining regional service information for a business in accordance with one aspect of the present invention;

FIG. 8 is a representation of a web page showing the results of a search engine query in accordance with one aspect of the present invention; and

FIGS. 9 and 10 comprise a flow diagram generally representing steps for providing regional service merchant details for a search in accordance with one aspect of the present invention.

FIG. 11 is a representation of a data entry for maintaining the originating data source service information for a business in accordance with one aspect of the present invention;

### DETAILED DESCRIPTION EXEMPLARY OPERATING ENVIRONMENT

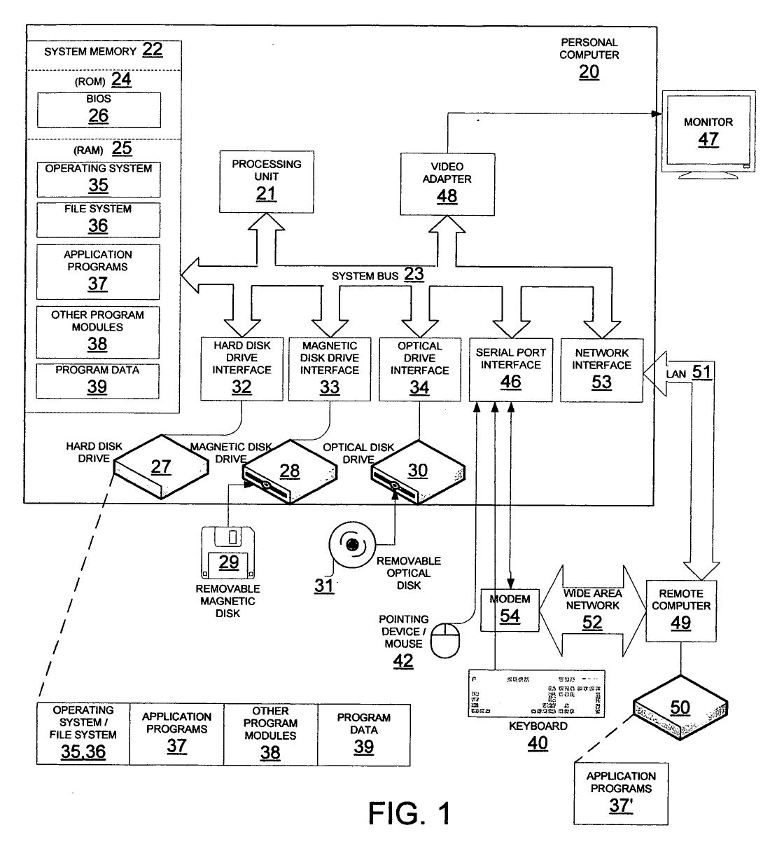

FIG. 1 and the following discussion are intended to provide a brief general description of a suitable computing environment in which the invention may be implemented. Although not required, the invention will be described in the general context of computer-executable instructions, such as program modules, being executed by a personal computer. Generally, program modules include routines, programs, objects, components, data structures and the like that perform particular tasks or implement particular abstract data types.

Moreover, those skilled in the art will appreciate that the invention may be practiced with other computer system configurations, including hand-held devices, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

With reference to FIG. 1, an exemplary system for implementing the invention includes a general purpose computing device in the form of a conventional personal computer 20 or the like, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system 26 (BIOS), containing the basic routines that help to transfer information between elements within the personal computer 20, such as during start-up, is stored in ROM 24. The personal computer 20 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD-ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide non-volatile storage of computer readable instructions, data structures, program modules and other data for the personal computer 20. Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read-only memories (ROMs) and the like may also be used in the exemplary operating environment.

A number of program modules may be stored on the hard disk, magnetic disk 29, optical disk 31, ROM 24 or RAM 25, including an operating system 35, (including a file system 36 therein and/or associated therewith), one or more application programs 37, other program modules 38 and program data 39. A user may enter commands and information into the personal computer 20 through input devices such as a keyboard 40 and pointing device 42. Other input devices (not shown) may include a microphone, speaker, joystick, game pad, satellite dish, scanner or the like. These and other input devices are often connected to the processing unit 21 through a serial port interface 46 that is coupled to the system bus, but may be connected by other interfaces, such as a parallel port, game port or universal serial bus (USB). A monitor 47 or other type of display device is also connected to the system bus 23 via an interface, such as a video adapter 48. In addition to the monitor 47, personal computers typically include other peripheral output devices (not shown), such as speakers and printers.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise-wide computer networks, intranets and the Internet.

When used in a LAN networking environment, the personal computer 20 is connected to the local network 51 through a network interface or adapter 53. When used in a WAN networking environment, the personal computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

### Providing Service Listings in an Internet Search Engine or Internet Directory

Briefly described, the present invention provides a method and system for allowing merchants that are outside of a given geographical boundary, but who provide service to the geographical boundary, to be included in a result set (e.g., of a bounded query) despite the merchant's actual physical location being located outside the geographical boundary, and despite the search term containing non-obvious information about a placename, whether or not it is inside the given geographic boundary, that serves the purpose of binding that search term to the placename's location. In addition, the system permits the merchant's advertisement to be included in a result set for a proximity query directed to a location in the area. To this end, the present invention provides additional non-obvious location bindings (e.g., neighborhoods) in which the regional service merchant provides services, but in which the regional service merchant does not have a physical address, and in which the exact identifiable binding location is unknown based merely on the contents of the search term. A binding is created between the regional service merchant and each business and each category to which the regional service merchant belongs. The “category” phrase part is one of three parts of the Local Name search phrase (the other two being the join word preposition and the placename). The “category” phrase part is typically non-geographic, yet also allows for the proper contextual parsing of “New York pizza near San Francisco”, where “New York pizza” is the category phrase part. The category phrase is also referenced herein as the “Descriptive Word-Phrase”. The system facilitates grammatically-correct linguistic order through the use of the three phrase parts, yet it does not need to require such order. The system also allows for mis-spellings, slang, “L33t speak”, and other derivatives. The join word preposition may be a Null value if entered in the join word field as Null, as in the example “pizza SOMA”. The phrase parts may also be in any order, as in the examples “near SOMA pizza” and “SOMA pizza”.

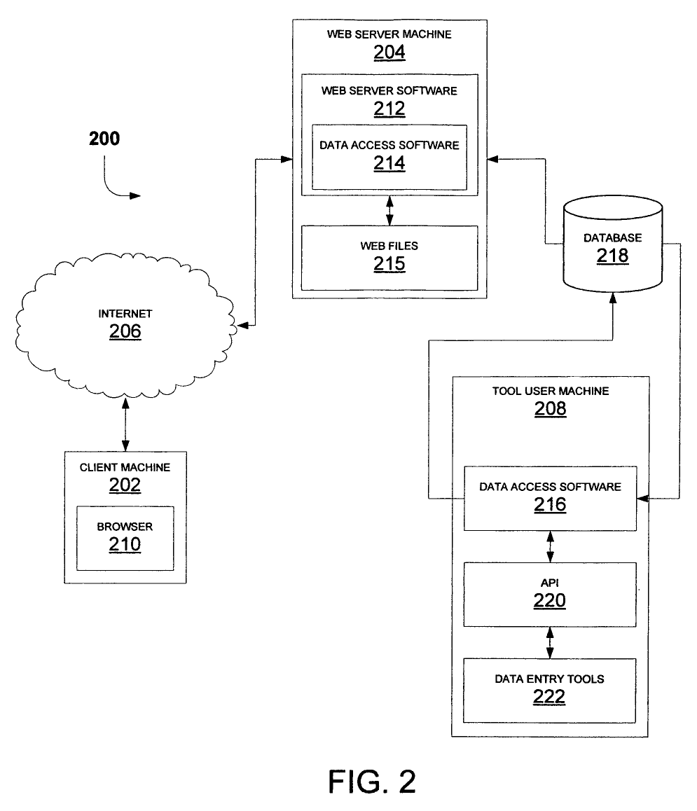

FIG. 2 is a functional block diagram that, together with the following discussion, provides a description of an illustrative system 200 for providing service advertisements in electronic search engine in accordance with the present invention. The system 200 includes a client machine 202 (e.g., the computer system 20) coupled to a web server machine 204 (e.g., the remote computer 49). The client machine 202 and the web server machine 204 may communicate with each other through the Internet 206. Alternatively, the client machine 202 and the web server machine 204 may be connected in another manner, such as through a Local Area Network described above. In addition, the functions of the client machine 202 and the web server machine may be provided on one physical machine.

A tool user machine 208 is similarly coupled to the web server machine 204, via the Internet 206, a Local Area Network, or the like. Alternatively, the functions of the web server machine 204 and the tool user machine 208 may be provided on one machine, or the functions of the client machine 202 and the web server and tool user machines 204, 208 may be provided on one machine or may be distributed over multiple machines.

The client machine 202 includes network access software, such as a browser 210. The web server machine 204 includes web server software 212 for accessing and serving content to the browser upon request. The web server software 212 may be, for example, Apache software. As part of its features, the web server software 212 may include data access software 214. The data access software 214 includes database query software, such as structured query language (SQL) software, for example as is provided with Microsoft Corporation's SQL server software. The web server machine 204 also includes web files 215 that provide web pages for requesting search engine advertisements. The web server machine includes or is associated with at least one database 218.

The tool user machine 208 includes a special application programming interface (API) 220. As is described further below, the data entry tool set 222 accesses the database 218 via the API 220 and data access software 216. The API 220 exists to automatically enforce various business rules that are required to maintain the logical consistency of the data in the database. These rules include restrictions on the type and nature of regional service merchants (e.g., the regional service merchant must have glyphs and/or text, and so forth that match the enduser's natural language phrase query).

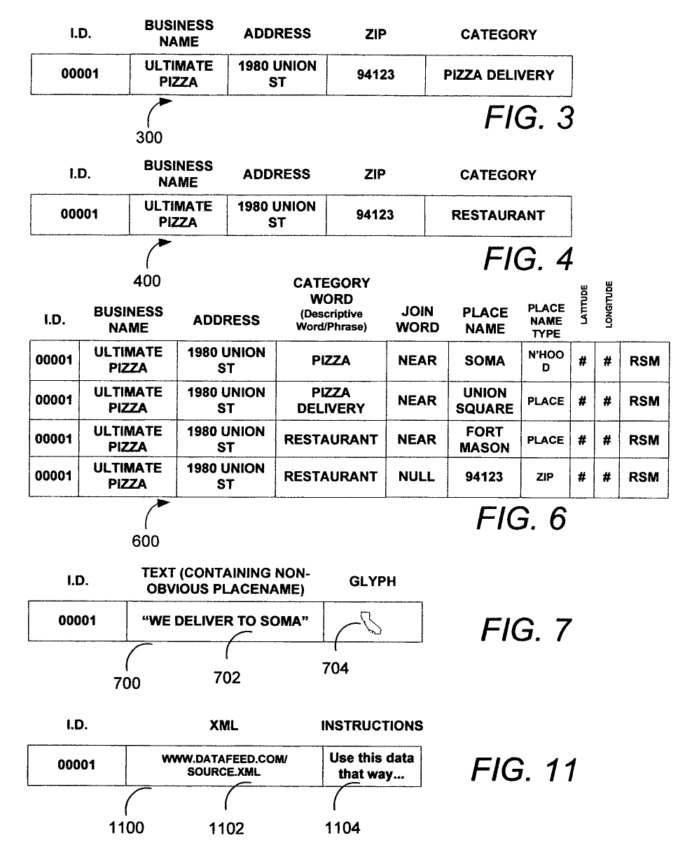

The database 218 maintains a schema that includes at least one entry for each business listed with the search engine. The business information may be grouped, referenced and categorized according to a defined taxonomy. The taxonomy may be hierarchical (as is the case with an Internet directory) or flat (as is the case with an Internet search engine) or both (as is the case when the two are combined), where each keyword phrase (also called a “Local Name” herein) is its own category in the hierarchy. For a typical business, the advertisement may include the category (e.g., “pizza delivery”), the location of the business (i.e., address), the ZIP code of the location, a unique identification for the business and the name of the business. An example of such a business entry 300 is shown in FIG. 3. For ease of explanation, a field descriptor bar is shown above the corresponding columns of the business entry 300. The field descriptor bar provides a textual field description for each of the associated columns in the business entry 300 and is not typically included in the business entry. For the entry shown in FIG. 3, a pizza delivery business is listed as being located at 1980 Union Street, in the ZIP code 94123, with a name “Ultimate Pizza”, and an identification of “00001”. The business may also be listed in other categories. For example, Ultimate Pizza may also be listed under the category “restaurants”. For each additional category, a separate entry 400, such as is shown in FIG. 4, is entered in the database for the business. An Internet search engine provider may enable a business to have multiple category entries, keyword phrases, ads, locations, ways to contact the company, and or campaigns. These data services permit the business to be found utilizing a number of different search terms or directory categories.

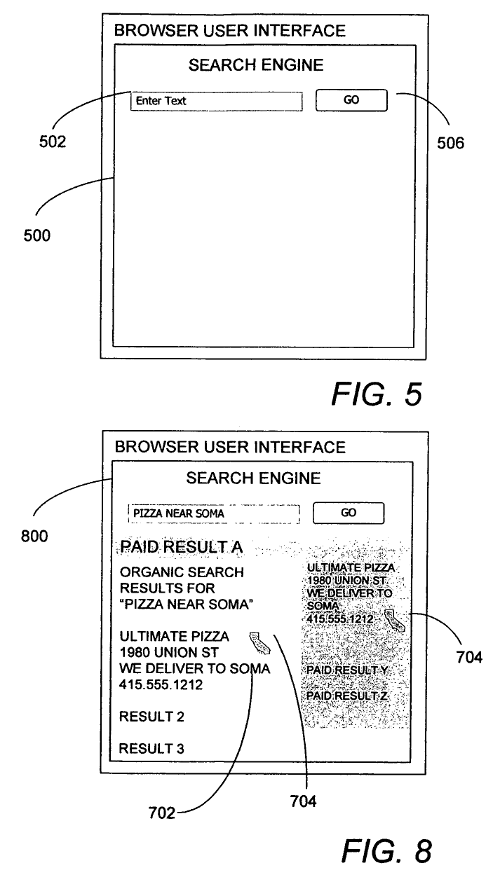

To locate a business, a user first navigates to a search engine website, such as the web page 500 shown in FIG. 5. As one skilled in the art will appreciate, remote files such as the web page 500 may be accessed, such as via the File Transfer Protocol (FTP) via the Internet 206, or as a file copy over the optional Local Area Network, or as an SMS text message from a wireless device, or as a phone call from a wireless phone, wireless phone, or VOIP application, but preferably via the standard Hypertext Transfer Protocol (HTTP) which is now most prevalent on the Internet. To access a remote web file, a user may, for example, enter a uniform resource locator (URL) in the browser 210 on the client machine 202. In one example, the web page 500 is one of the web files 215 and is served to a user by the web server machine 202.

The web page 500 includes a data entry field 502 for entering search terms or directory categories, such as a category or business name. The user may request either a boundary query, such as by entering a ZIP code, city, or neighborhood, or a proximity query, by entering an address, ZIP code, coordinates, or the like. An additional field (intentionally not shown in FIG. 5, in order to better illustrate the flexibility of our invention) may be provided for selecting a particular type of search. Selecting a field may pop up a data entry field for entering the proper information, such as an address that is to be used in a proximity query. Alternatively, the user may be navigated to another page to enter the address or location information.

After the user enters the appropriate information, a search is requested (e.g., by clicking on a “GO” button 506). The data entered by the user is forwarded to the web server machine 202, and is received by the web server software 212. The data access software 214 matches the search term and extracts the appropriate business advertisements from the database 218.

It can be understood that the present invention is highly amenable to implementation on the web in a variety of configurations that are typical of internet search engines and internet directories, and a database or any other data store (i.e. a map database) may be utilized for business advertisement retrievals. To this end, retrieval can be accomplished via the most basic access to a computer file for small business sets or through something as complicated as an optimized SQL query for large business sets. An exemplary process that may be used by the data access software 214 to retrieve appropriate businesses and/or name information is described in U.S. application Ser. No. 09/629,275, filed Jul. 31, 2000, entitled “Business Directory Search engine,” and incorporated herein by reference. Briefly described, the data access software 214 matches the location and name or category information entered by a user with entries in the database to return a business advertisements result set. The data access software may need to convert address information to a longitude and latitude point, and may have to use an intelligent inquiry to obtain appropriate matches. The records are extracted by the data access software 214, forwarded to the web server machine, which in turn serves the records to the client machine 202 so that the records may be displayed by the browser 210.

As described in the background section, the entries described above do not permit a business that is servicing an area that is described by non-obvious location—binding words or phrases (aka “placenames”), but is not listed in the area (a “regional service merchant”), to be returned in the result set for a search directed to the area. Using the previous example, Ultimate Pizza may deliver pizza to “Union Square” and “SOMA”, in addition to zip code 94123. If only the advertisements above were available for the business, then a bounded query search directed to “Union Square” and “SOMA” would not return Ultimate Pizza. In fact, “Union Square” might return a New York City result when in this example the San Francisco placename of the same name is what is intended. Furthermore, “SOMA” which is a nickname for “South of Market” might return something else related to “soma”. (Using a more universal example, “Wall Street” may return any number of responses that are not related to the intended street, neighborhood, placename, business name, building, or industry.) In addition, a proximity search directed to a location in one of these ZIP codes would not return Ultimate Pizza, unless 1980 Union Street is coincidentally close enough to the location to be in the result set for the search.

In accordance with one aspect of the invention, separate entries are provided for a regional service merchant that associate the regional service merchant with additional location-infused keyword phrases (aka “Local Name” or the simpler “keyword phrase”), whether obvious or not (e.g., “Union Square” or “SOMA”) in which the regional service merchant provides services. For each business and each category to which a regional service merchant belongs, an entry is written to the database 218 for associating each location-infused keyword phrase that the business services with the regional service merchant.

Again referencing the example above, separate entries are entered in the database 218 for each ZIP code and category to which Ultimate Pizza belongs. FIG. 6 shows four additional entries 600 for Ultimate Pizza that are used to indicate that the business services are provided to SOMA (a neighborhood), Union Square (a place), Fort Mason (a place), and 94123 (a ZIP code). The system may also store personalized location-binding descriptions (i.e. “Where Mom and Dad live”) and description types (i.e. substituting the word ‘crib’ for ‘house’). Each entry additionally includes information that the entry is a regional service merchant entry (“RSM”). Each entry additionally includes information that shows the precise location of the placename (which can be done in several ways, but herein uses “Latitude” and “Longitude”), as well as the type of placename (“Placename Type”) it is, which turns a non-obvious location into an obvious one. In the example shown, this information is an additional field filled with “RSM” (or “Regional Service Merchant”), but other information could be utilized, such as writing the entry to a separate database, or maintaining a separate data store that includes a list of all regional service merchant entries.

The regional service merchant entries permit regional service merchants to be returned in a search directed to the serviced region, whether obvious or not. For a bounded query (e.g., directed to one or more placenames), the placenames are retrieved for that region and queried against merchants and categories and/or names that meet the search requirements. Because the regional service merchant entries include placename matches for regions serviced by the regional service merchant, the regional service merchant is included in a region search where one or more placenames match. For a proximity search, regional service merchants may be returned against a request made for a location within a placename in which the regional service merchants are registered.

In accordance with another aspect of the present invention, schema is maintained for the regional service merchants that includes lines of text and/or a glyph or glyphs. The text and/or a glyph may be maintained in a schema separate from the regional service merchant entries, or may be maintained as a separate entry and accessed via the SQL software, such as the data access software 214.

When a search is conducted, the text and/or glyphs are returned along with the regional service merchant's business advertisement so as to explain to a user why a business not physically residing in the search area has been included in the result set. The text or glyph may indicate, for example, a link to a map indicating the complete set of locations served by this particular store. The text and or glyph does not need to reference a geographic point or area, although the glyph 704 used in FIG. 7 represents California.

FIG. 7 shows an example of an entry 700 for the text and glyph schema maintained for the regional service merchant Ultimate Pizza described in the above example. In this example, the text and glyph schema is maintained separate from the regional service merchant schema. The business ID is also maintained with the entry so that the text and glyph may be easily cross-referenced with the regional service merchant schema. In FIG. 7, both a text entry “pizza near SOMA” 702 and a glyph 704, are maintained for Ultimate Pizza. One or both may be returned with the result set, and the web server machine and/or the browser may choose to display one or both based upon the browser's capabilities and/or available web page space. The text may also be used as free text to describe the region serviced by the regional service merchant (e.g., “We deliver to SOMA”). As is described in the background section, an RSM merchant may be an eCommerce merchant, an online publisher, an online advertiser, or an offline merchant with a physical address. The text and/or glyph may define the region serviced by the eCommerce merchant, and may convey the fact that the regional service merchant is an eCommerce business, for example.

FIG. 11 shows an example of an entry 1100 for the data source for the regional service merchant Ultimate Pizza described in the above example, as well as the instructions on how to use the data, all while maintaining the schema. In this example, the data source and data source instructions schema is maintained separate from the regional service merchant schema. The business ID is also maintained with the entry so that the text and glyph may be easily cross-referenced with the regional service merchant schema. In FIG. 11, both a text entry “WWW.DATAFEED.COM/SOURCE.XML” 1102 and the instructions “Use this data that way . . . ” 1104, are maintained for Ultimate Pizza. One or both may be returned with the result set, and the web server machine and/or the browser may choose to display or use one or both based upon the browser's capabilities and/or available web page space. A person skilled in the art will appreciate the functionality provided by an XML data feed and the instructions on how to use that particular XML data feed, and that data feed technology comes in additional formats, for example RSS and RDF.

Entries in the database 218 may be entered or amended via the data entry tool set 222. The application programming interface 220 ensures that, if the business is listed as a regional service merchant, then text and/or glyph indicating that the business is a regional service merchant is stored in association with the business advertisement. This process ensures that text and/or a glyph is available so that the regional service merchant is properly portrayed as such to the user. To do this, the application programming interface 220 may, for example, ensure that information regarding the fact that the business is a regional service merchant is stored with the regional service merchant entries (e.g., the entry “RSM”), and that text and/or glyph is stored in association with a regional service merchant entry.

FIG. 8 shows a web page 800 that displays the results of a search conducted via the search page 500. The search is directed to “pizza near SOMA”. The data access software finds a closest match to be the phrase “pizza near SOMA”, and returns merchants that have an ad associated with “pizza near SOMA”. The search returns, among other merchants, Ultimate Pizza. In this example, regional service merchants are returned at the top of the list, but they could be listed alphabetically, in accordance with fees paid to the search engine provider, or in another desired order. The search may return the results whether or not a financial relationship has been established with the companies in the result set, unless that company is an active advertiser, and the result set is for advertisements. However, active advertisers may also be included in non-advertisement result sets (i.e. as is the case with the left side search engine results pages found on www.google.com). The text 702 and glyph 704 are returned with the result set, and are displayed on the page along with the Ultimate Pizza advertisement so that a user may know that the advertisement is that of a regional service merchant. This step is accomplished successfully even though the merchant is not in SOMA and even though the search engine was not able to determine that the word “SOMA” was a neighborhood in San Francisco.

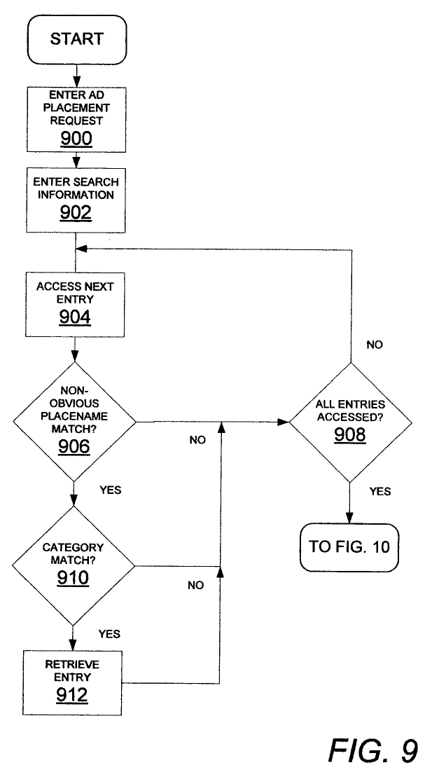

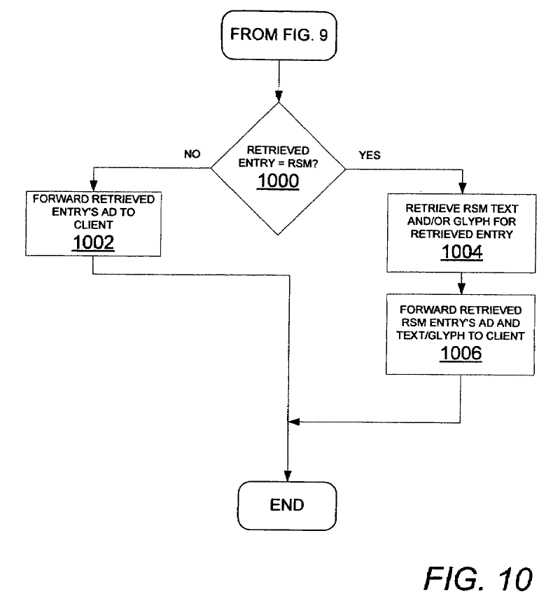

Turning now to an explanation of the operation of the present invention, FIGS. 9 and 10 show a general overview of a process for returning a regional service merchant in response to a search directed with or without identifying a specific region in which the regional service merchant service does not have a physical address in accordance with one aspect of the present invention. Beginning at step 900, a user enters a request for business advertisements by selecting or inputting location and category information, together or separately. The user may, for example, enter a category and a zip code via the search engine web page 300, or may, for example, enter non-obvious location information as part of the search term via the search engine web page 300.

At step 902 the stored regional service merchant (or “RSM”) data about a business is retrieved. Retrieval can be accomplished via the most basic access to a computer file for small business sets or through something as complicated as an optimized SQL query for large business sets. The invention may be effectively practiced using any number of data stores.

At step 904, the data access software accesses an entry, and determines if it matches the entered search term which contains the non-obvious placename. If not, then the data access software determines if all entries have been accessed (step 908). If not, then the process loops back to step 904 and the data access software accesses the next entry. This process continues until the data access software accesses a match for the entire search term, and for its pre-concatenated parts, which are composed of the category word, the join word, and the non-obvious placename, which may be assembled in any order, where step 906 branches to step 910. The data access software then determines if the category word of the entry having the correct join word and the correct placename matches the search term, and if not, step 910 branches to step 908 where a determination is made whether all records have been accessed. If not, then the process loops back to step 904 and the data access software accesses the next record. This process continues until the data access software accesses a match for the entire search term and for its pre-concatenated parts, where step 906 branches to step 910, and step 910 branches to step 912, where the entry matching the category word, the join word, and the non-obvious placename is retrieved. Step 912 then branches to step 908, where a determination is made whether all relevant entries have been accessed. If not, then the process loops back to step 904 where the next entry is accessed.

The foregoing steps describe a simplified approach to retrieving relevant entries. It can be understood that a more sophisticated logic may be used to speed up the process. For example, in a high performance implementation, steps 904 to 912 may be simultaneously executed in one omnibus query to an optimizing SQL access layer. Use of SQL in this fashion is commonplace and providing as much information about the desired result set as possible to the SQL optimizer generally results in the best performance.

In any event, after all entries have been accessed, then step 908 branches to FIG. 10, where at step 1000 a determination is made whether a retrieved entry is a regional service merchant. If not, then step 1000 branches to step 1002, where the retrieved entry's advertisement is forwarded to the client machine for viewing in the browser. If the entry is a regional service merchant, then step 1000 branches to step 1004, where the RSM glyph and/or text for the entry are retrieved. The regional service merchant entry and the RSM glyph and/or text are then served to the client machine at step 1006. In practice, the RSM entries and non-RSM entries may be sent to the client together, and sorting and other formatting parameters may be applied before the entries are sent.

The present invention is advantageous in that it permits a regional service merchant to be displayed in the result set for a search directed to an area that may be named in a non-obvious manner, and despite the regional service merchant not having a physical location in the area. In addition, the use of the text and/or glyph describes to the user why the regional service merchant is displayed so as to avoid confusion.

While the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention. It is especially noteworthy that this invention is amenable to deployment on a variety of network topologies, and while the exemplary embodiment is described with reference to directory access happening over the Internet and tools use happening on a LAN-based client machine other topologies (such as the reverse of the exemplary embodiment, or either hybrid) are readily practicable.

What is claimed is:

1. At least one computer-readable medium having computer-executable instructions, which when executed perform steps, comprising: maintaining location binding information associating an advertiser or publisher or merchant with a region in which the advertiser or publisher or merchant has been identified as having an active association or interest regardless of whether the advertiser or publisher or merchant has a physical location in the region; receiving a request from the advertiser or publisher or merchant corresponding to a requested region; receiving a request from the advertiser or publisher or merchant corresponding to a requested natural language phrase; receiving a request from an enduser using a web-based search or directory navigation system, corresponding to a natural language phrase; and searching the contents of information and advertising to determine whether the advertiser or publisher or merchant provides information or advertising that matches the requested natural language phrase, and if so, returning information regarding the advertiser or publisher or merchant.

2. The computer-readable medium of claim 1 in which the Local Name contains three parts; a Descriptive Word-Phrase, a join word, and a placename word or phrase. The three parts of the Local Name are always associated with its corresponding Local Name in the system to facilitate accurate construction and deconstruction of the Local Name within the system. Outside the system, the three parts may or may not be included when the Local Name is delivered to a user or to a third-party application.

3. The system of claim 2 in which the Descriptive Word-Phrase can be any word or phrase.

4. The system of claim 2 in which the Join Word is a preposition.

5. The system of claim 2 in which the placename can be any word or phrase.

6. The system of claim 5 in which the placename contains tokens representing location-specific geographical features.

7. The system of claim 6 in which the tokens are extracted through a process of parsing.

8. The system of claim 7 in which the extracted tokens are used as keys in a database lookup.

9. The system of claim 2 in which the Local Name or set of Local Names is modified programatically to include additional tokens detailing how to process these search terms to return a result set containing text and or a glyph, in addition to the stored information about the regional business.

10. The system of claim 9 in which the Local Name or set of Local Names is modified programatically to include additional tokens detailing how to associate with, disassociate from, or otherwise influence any text or glyph stored within the system.

11. The system of claim 2 in which the Local Name or set of Local Names is modified programatically to include additional tokens detailing external data sources and the instructions on how those external data sources are to be used.

12. At least one computer-readable medium having computer-executable instructions, which when executed perform steps, comprising: maintaining location binding information associating an advertiser or publisher or merchant with a region in which the advertiser or publisher or merchant has been identified as having an active association or interest regardless of whether the advertiser or publisher or merchant has a physical location in the region; receiving a request from the advertiser or publisher or merchant corresponding to a requested region; receiving a request from the advertiser or publisher or merchant corresponding to a requested natural language phrase; receiving a request from an enduser using a wireless-based search or directory navigation system, corresponding to a natural language phrase; and searching the contents of information and advertising to determine whether the advertiser or publisher or merchant provides information or advertising that matches the requested natural language phrase, and if so, returning information regarding the advertiser or publisher or merchant.

13. The computer-readable medium of claim 12 in which the Local Name contains three parts; a Descriptive Word-Phrase, a join word, and a placename word or phrase. The three parts of the Local Name are always associated with its corresponding Local Name in the system to facilitate accurate construction and deconstruction of the Local Name within the system. Outside the system, the three parts may or may not be included when the Local Name is delivered to a user or to a third-party application.

14. The system of claim 13 in which the Descriptive Word-Phrase can be any word or phrase.

15. The system of claim 13 in which the Join Word is a preposition.

16. The system of claim 13 in which the placename can be any word or phrase.

17. The system of claim 16 in which the placename contains tokens representing location-specific geographical features.

18. The system of claim 17 in which the tokens are extracted through a process of parsing.

19. The system of claim 18 in which the extracted tokens are used as keys in a database lookup.

20. The system of claim 13 in which the Local Name or set of Local Names is modified programatically to include additional tokens detailing how to process these search terms to return a result set containing text and or a glyph, in addition to the stored information about the regional business.

21. The system of claim 20 in which the Local Name or set of Local Names is modified programatically to include additional tokens detailing how to associate with, disassociate from, or otherwise influence any text or glyph stored within the system.

22. The system of claim 13 in which the Local Name or set of Local Names is modified programatically to include additional tokens detailing external data sources and the instructions on how those external data sources are to be used.

23. At least one computer-readable medium having computer-executable instructions, which when executed perform steps, comprising: maintaining location binding information associating an advertiser or publisher or merchant with a region in which the advertiser or publisher or merchant has been identified as having an active association or interest regardless of whether the advertiser or publisher or merchant has a physical location in the region; receiving a request from the advertiser or publisher or merchant corresponding to a requested region; receiving a request from the advertiser or publisher or merchant corresponding to a requested natural language phrase; receiving a request from an enduser using a voice-based search or directory navigation system, corresponding to a natural language phrase; and searching the contents of information and advertising to determine whether the advertiser or publisher or merchant provides information or advertising that matches the requested natural language phrase, and if so, returning information regarding the advertiser or publisher or merchant.

24. The computer-readable medium of claim 23 in which the Local Name contains three parts; a Descriptive Word-Phrase, a join word, and a placename word or phrase. The three parts of the Local Name are always associated with its corresponding Local Name in the system to facilitate accurate construction and deconstruction of the Local Name within the system. Outside the system, the three parts may or may not be included when the Local Name is delivered to a user or to a third-party application.

25. The system of claim 24 in which the Descriptive Word-Phrase can be any word or phrase.

26. The system of claim 24 in which the Join Word is a preposition.

27. The system of claim 24 in which the placename can be any word or phrase.

28. The system of claim 27 in which the placename contains tokens representing location-specific geographical features.

29. The system of claim 28 in which the tokens are extracted through a process of parsing.

30. The system of claim 29 in which the extracted tokens are used as keys in a database lookup.

31. The system of claim 24 in which the Local Name or set of Local Names is modified programatically to include additional tokens detailing how to process these search terms to return a result set containing text and or a glyph, in addition to the stored information about the regional business.

32. The system of claim 31 in which the Local Name or set of Local Names is modified programatically to include additional tokens detailing how to associate with, disassociate from, or otherwise influence any text or glyph stored within the system.

33. The system of claim 24 in which the Local Name or set of Local Names is modified programatically to include additional tokens detailing external data sources and the instructions on how those external data sources are to be used.
